(19) United States
(12) Patent Application Publication
(10) Pub. No.: US 2016/0377767 A1
(43) Pub. Date: Dec. 29, 2016

(54) LENS ASSEMBLY

(71) Applicant: FUJIFILM Corporation, Tokyo (JP)

(72) Inventors: Shinichiro SONODA, Ashigarakami-gun (JP); Tatsuya YOSHIHIRO, Ashigarakami-gun (JP)

(73) Assignee: FUJIFILM Corporation, Tokyo (JP)

(21) Appl. No.: 15/263,846

(22) Filed: Sep. 13, 2016

Related U.S. Application Data
(63) Continuation of application No. PCT/JP2015/001235, filed on Mar. 6, 2015.

(30) Foreign Application Priority Data
Mar. 17, 2014 (JP) 2014-053048

(51) Int. Cl. G02B 1/118; G02B 5/00; G02B 1/113

(52) U.S. Cl. CPC G02B 1/118; G02B 1/113; G02B 5/003

(57) ABSTRACT

One lens is provided with a functional film formed of a fine uneven structure film throughout an entire region including an edge portion of a lens surface facing the other lens, and a portion of the fine uneven structure film formed in the edge portion is filled with a flattening member and is thus flattened. The lens is disposed so as to be in contact with the other lens in the edge portion in which the flattening member is formed, thereby assembling a lens assembly.

### CROSS-REFERENCE TO RELATED APPLICATIONS

This application is a Continuation of PCT International Application No. PCT/JP2015/001235 filed on Mar. 6, 2015, which claims priority under 35 U.S.C. §119(a) to Japanese Patent Application No. 2014-053048 filed on Mar. 17, 2014. Each of the above applications is hereby expressly incorporated by reference, in its entirety, into the present application.

### BACKGROUND OF THE INVENTION

1. Field of the Invention

The present invention relates to a lens assembly constituted by bringing two lenses into contact with each other at a rim portion and disposing the lenses opposite to each other.

2. Description of the Related Art

In the related art, in optical elements (lenses) in which translucent media such as glass media and plastic media are used, when surface reflection frequently occurs, flares or ghosts are frequently generated, and the transmittance decreases, and thus antireflection films made of thin dielectric films are provided on the surfaces. These antireflection films are required to be capable of producing favorable antireflection effects even when the incidence angle ranges of the fluxes of light incident on optical elements are wide. In order to obtain strong antireflection effects in wide incidence angle ranges, it is required that the difference in refractive index between films constituting interfaces between the air and a layer or between a layer and a layer is small. As the above-described antireflection structure films, functional films formed of films with fine uneven structures that are equal to or smaller than the wavelengths of visible light are known (JP2005-275372A, JP2010-66704A, and the like).

Generally, in optical devices such as cameras for silver salt films, digital still cameras, video cameras, digital video cameras, telescopes, binoculars, projectors, and copiers, optical systems constituted by combining a plurality of lenses are installed.

Lenses are stored and held in lens barrels; however, in order to shorten the lengths of optical systems as a whole or improve assembly accuracy, there is a case in which lens assemblies are assembled by bringing adjacent lenses into direct contact with each other at their outer circumferential portions and the lenses are disposed in lens barrels in a state in which the lenses are brought into contact with each other at their outer circumferential portions. This action of bringing these lenses into direct contact with each other is referred to as marginal contact.

For example, as illustrated in FIG. 7, two lenses 41 and 42 are stored in a lens barrel 3 and are fixed to each other using a holding member (pressing ring) 8 in a state of being brought into contact with each other at an edge portion 45 therebetween.

In a case in which a functional film formed of a fine uneven structure film 44 is formed on a surface 41b of one lens 41 constituting a lens assembly which faces the other lens 42, a constitution in which the other lens 42 is pressed onto the fine uneven structure film 44 on the lens 41 in the edge portion 45 in which both lenses are in contact with each other is obtained. The fine uneven structure film has significantly lower film hardness (is weaker) than antireflection films made of dielectric films. Therefore, when two lenses are brought into marginal contact with each other, there is a case in which the contact of the surface provided with the functional film with the other surface causes the functional film to break at the contact portion and the antireflection effects degrade. In addition, there is another case in which part of the broken functional film scatters onto the lens surfaces and causes optical performance to degrade.

As methods for solving the above-described problem, in JP2009-128844A, a lens assembly having a constitution in which, as illustrated in FIG. 8, a lens 51 including a functional film formed of a fine uneven structure film 54 on one surface and a lens 52 which faces a surface 51b on which the functional film on the lens 51 is formed and has a diameter φ2 larger than the diameter φb of the surface 51b on which the functional film is formed are provided, and an edge portion of the surface 51b on which the functional film is formed and an optical surface 52a of the lens 52 having a diameter larger than the diameter of the surface on which the functional film is formed are in marginal contact with each other is proposed.

When the lens 51 is brought into marginal contact at the edge at which the fine uneven structure film is not formed as illustrated in FIG. 8, compared with a case in which the lens is brought into marginal contact with the lens 42 having a diameter φ2 smaller than the diameter φ1b of the lens surface on which the fine uneven structure film 44 is formed as illustrated in FIG. 7, it is considered that the problem of breakage (peeling or chipping) of the fine uneven structure film is suppressed.

### SUMMARY OF THE INVENTION

Although not illustrated in FIGS. 7 and 8, generally, in light radiation ineffective regions of lenses, light shield films for preventing ghosts are provided (JP2013-24922A). Meanwhile, antireflection films need to be formed at least in light radiation effective regions. However, when there are gaps in the boundaries between light radiation effective regions and light radiation ineffective regions on which the light shield films are formed, it is not possible to fully suppress ghosts, and thus it is necessary to prevent gaps from being generated. In addition, in order to prevent gaps from being generated in the boundaries between light radiation effective regions and light radiation ineffective regions, it is preferable to form antireflection films so as to partially overlap light radiation ineffective regions.

When an antireflection film is formed so as to partially overlap a light radiation ineffective region, even in the edge portion in FIG. 8 in which the lens 51 and the lens 52 are in contact with each other, a fine uneven structure film is formed. In such a case, it is needless to say that there is a problem of breakage of the fine uneven structure film in the contact portion.

In addition, in optical systems having high sensitivity regarding the eccentricity of lenses, there is a case in which, in lens barrels, lenses are fixed to each other after the eccentricity is adjusted. There is a case in which the two lenses 51 and 52 brought into marginal contact with each other are rotated for adjustment in the arrow direction in a plane orthogonal to an optical axis 9, thereby aligning the lenses as illustrated in FIG. 9A or there is a case in which the two lenses 51 and 52 are shifted for adjustment in the arrow directions in a plane orthogonal to the optical axis 9, thereby aligning the lenses as illustrated in FIG. 9B. During the above-described alignments, breakage of fine uneven structure films may be significant, and thus, during the constitution of lens assemblies, it is a critical object to prevent functional films from being broken.

The invention of the present application has been made in consideration of the above-described circumstances, and an object of the present invention is to provide a lens assembly which, in lens assemblies constituted by bringing a lens including functional films formed of fine uneven structure films into marginal contact with another lens, can be easily assembled with high assembly accuracy without breaking functional films.

A lens assembly of the present invention is a lens assembly constituted of two lenses which have light radiation effective portions facing each other and are disposed such that one of the lenses comes into contact with the other lens at an edge portion that is a boundary between a curved surface and an outer peripheral portion of the one lens, in which the one lens has a functional film formed of a fine uneven structure film throughout an entire region including an edge portion of a lens surface facing the other lens, and a portion of the fine uneven structure film within a light radiation ineffective portion of the one lens extending over the curved surface and the outer peripheral portion forming the edge portion and including the edge portion is filled with a flattening member and is thus flattened.

Here, a period (average pitch) of fine unevenness of the fine uneven structure film is set to be sufficiently smaller than the wavelengths of light being used.

It is preferable that a light shield film is provided in at least the light radiation ineffective portion in the one lens. It is more preferable that each of the two lenses is provided with a light shield film in a light radiation ineffective portion.

It is preferable that the flattening member is made of the same material as that of the light shield film.

It is also possible that, in the edge portion, the light shield film is provided between the fine uneven structure film and the lens surface.

It is preferable that the fine uneven structure film is made of a composition including a hydrate of aluminum or alumina as a main component.

The lens assembly of the present invention is a lens assembly constituted by bringing two lenses into contact with each other at the rim portion, and, in the functional film formed of the fine uneven structure film provided on the surface of one lens, the edge portion at which the lens is brought into contact with the other lens is filled with the flattening member and thus flattened, and thus it is possible to suppress the occurrence of chipping, peeling, and the like in the fine uneven structure film even when the lens is brought into contact with the other lens in the edge portion, that is, it is possible to easily assemble the lens assembly with high assembly accuracy without breaking the functional film.

### BRIEF DESCRIPTION OF THE DRAWINGS

FIG. 1 is a schematic sectional view illustrating the constitution of a lens assembly according to an embodiment of the present invention.

FIG. 2 is an enlarged view illustrating an edge portion in one lens.

FIG. 3 is an enlarged view illustrating a modified constitution example of the edge portion.

FIG. 4 is a view illustrating a manufacturing step flow of Example 1.

FIG. 5 is a view illustrating a manufacturing step flow of Example 2.

FIG. 6 is a view illustrating a manufacturing step flow of a comparative example.

FIG. 7 is a schematic sectional view illustrating the constitution of a lens assembly of the related art.

FIG. 8 is a schematic sectional view illustrating the constitution of a lens assembly of the related art.

FIG. 9A is a view for describing a method for adjusting eccentricity by rotating lenses with respect to an optical axis.

FIG. 9B is a view for describing a method for adjusting eccentricity by shifting lenses in a plane orthogonal to the optical axis.

### DESCRIPTION OF THE PREFERRED EMBODIMENTS

Hereinafter, an embodiment of the present invention will be described with reference to the accompanying drawings.

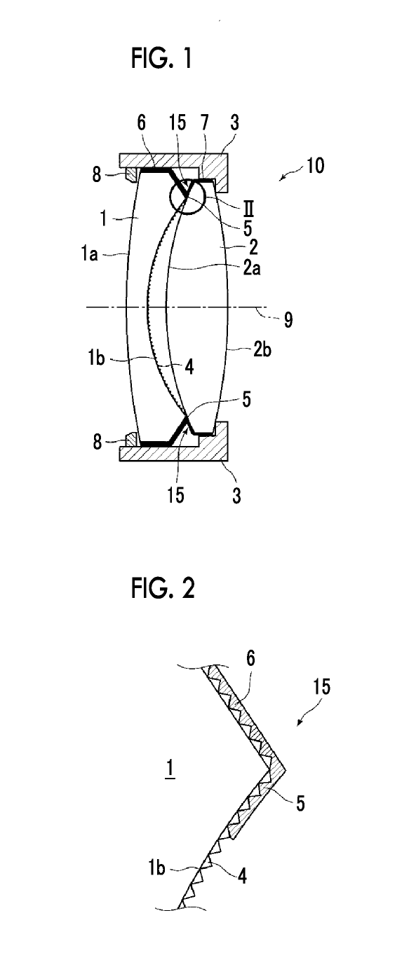

FIG. 1 is a schematic sectional view illustrating the constitution of a lens assembly 10 according to the embodiment of the present invention. As illustrated in FIG. 1, the lens assembly 10 is constituted of two lenses 1 and 2, and a functional film formed of a fine uneven structure film 4 is formed on a lens surface 1b of one lens 1 which faces the other lens 2. The two lenses 1 and 2 have light radiation effective portions facing each other and are disposed so as to come into contact with each other at an edge portion 15 that is a part of a light radiation ineffective portion. In addition, light shield films 6 and 7 are formed in the light radiation ineffective portions in the respective lenses 1 and 2.

Although light radiation effective portions and light radiation ineffective portions in lenses are actually determined by optical systems that are used, at least side surfaces held in lens barrels and the edge portion 15 at which lenses are brought into marginal contact with each other are part of light radiation ineffective portions.

The lens assembly 10 is constituted by inserting one lens 1 out of a pair of the lenses and the other lens 2 into a lens barrel 3, aligning the lenses in a state in which the lenses are brought into contact with each other in the edge portion 15, and then fixing the lenses by pressing the lenses using a pressing member 8.

FIG. 2 is a view illustrating the lens 1 in the edge portion 15 in which the lens 1 and the lens 2 are brought into contact with each other illustrated in FIG. 1 in an enlarged manner.

In the lens 1, the fine uneven structure film 4 is also formed on the edge portion. In addition, in the edge portion, a flattening member 5 is disposed on the fine uneven structure film 4, and concave portions in the fine uneven structure film are filled, thereby flattening the surface. The present embodiment has a constitution in which a light shield film 6 also functions as the flattening member 5.

Since the fine uneven structure film 4 is also formed in the edge portion, there is no gap between the light radiation effective portion and the light radiation ineffective portion, and it is possible to provide an antireflection function.

The fine uneven structure film 4 is a transparent fine uneven film including a hydrate of aluminum or alumina as a main component and has an antireflection function.

The hydrate of alumina is boehmite (denoted as Al₂O₃.H₂O or AlOOH) which an alumina monohydrate, bayerite (denoted as Al₂O₃.3H₂O or Al(OH)₃) which is alumina trihydrate (aluminum hydroxide), or the like.

The period (average pitch) of the unevenness of the fine uneven structure film 4 is set to be sufficiently smaller than the wavelengths of light being used (for example, infrared light or visible light). Specifically, the period of the fine unevenness is in an order of several tens of nanometers to several hundreds of nanometers. In the fine uneven structure film 4, the pitch refers to the distance between the top points of convex portions that are most adjacent to each other with a concave portion therebetween, and the depth refers to the distance from the top point of a convex portion to a bottom portion of an adjacent concave portion.

The fine uneven structure film has a structure in which the fine uneven structure film becomes more loose as being further away from base materials (the widths of voids corresponding to concave portions become large, and the widths of convex portions become small), and the refractive index becomes small as the fine uneven structure film is further away from base materials.

The average pitch of the unevenness can be obtained by, for example, capturing images of the surfaces of the fine uneven structure using scanning electron microscopes (SEMS), binarizing the images by means of image processing, and carrying out statistical treatments. Similarly, the film thicknesses of the fine uneven structure film can be obtained by capturing images of the sections of the fine uneven structure film and processing the images.

The fine uneven structure film 4 can be formed by forming a film including aluminum on a lens surface using a vapor-phase epitaxial method such as a vapor deposition method or a sputtering method and carrying out a thermal treatment. Examples of the film including aluminum include aluminum films, alumina films, and the like. For example, an Al film is formed using a sputtering method and is immersed in boiling water for five minutes as a hot water treatment, whereby a fine uneven structure film including a hydrate of alumina as a main component can be formed on the surface.

In the edge portion in which the lens comes into contact with the other lens 2, concave portions in the fine uneven structure portion 4 are filled with the flattening member 5 (here, the light shield film 6) which is a flattening film, and the fine uneven structure film 4 does not come into direct contact with the other lens 2, and thus the fine uneven structure film 4 does not break. Since the lenses are aligned in a state in which the lens is brought into contact with the other lens 2 in a portion of the flattening film 5, even when the lenses are rubbed with each other, the fine uneven structure film does not chip or peel off, and it is possible to assemble high-accuracy lens assemblies.

Meanwhile, on the surface 1a of the lens 1 on which the fine uneven structure film 4 is not formed and both surfaces 2a and 2b of the other lens 2, antireflection coatings (AR coatings) formed of dielectric multilayer films are provided. The antireflection coatings provided on the respective lens surfaces 1a, 2a, and 2b may be not dielectric multilayer films but fine uneven structure films. At this time, in the edge portion in which the other lens 2 comes into contact with the lens 1, it is needless to say that concave portions in the fine uneven structure film are preferably filled with the flattening film.

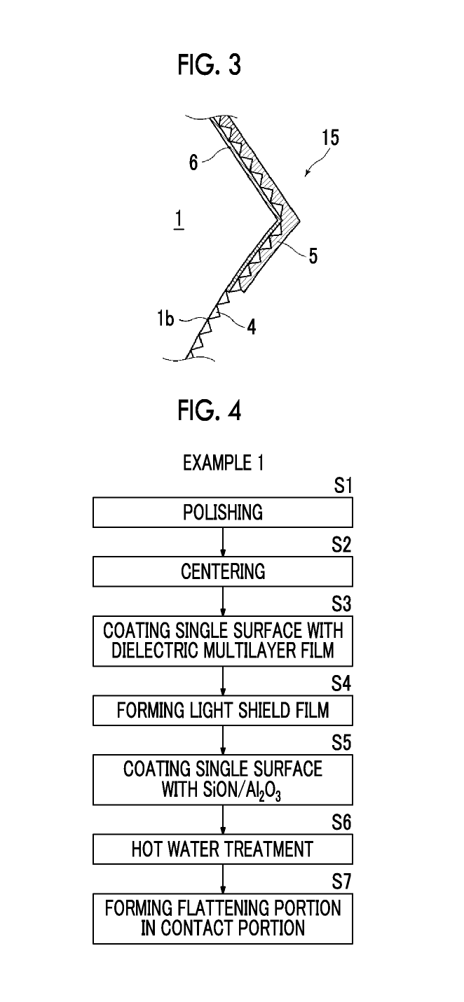

FIG. 3 is an enlarged view illustrating a design modification example of the edge portion 15 of the lens 1.

The lens assembly is constituted by first forming a light shield film in the light radiation ineffective portion in the lens, then, forming the fine uneven structure film 4 in part of the light radiation effective portion and the light radiation ineffective portion, and, finally, filling concave portions in the fine uneven structure portion 4 in the edge portion with the flattening member 5 so as to flatten the surface. Therefore, in the edge portion, the light shield film 6, the fine uneven structure film 4, and the flattening member 5 are sequentially laminated together from the surface 1b side of the lens.

In this case, the flattening member 5 is not particularly limited as long as the flattening member is a material capable of filling concave portions in the fine uneven structure film so as to flatten the surface and may or may not be constituted of a light shield material. For example, the flattening member can be constituted of a transparent acrylic resin. However, it is preferable to use a light shield material as the flattening member 5 so as to enable the flattening member to function as part of the light shield film from the viewpoint of preventing ghosts. As the light shield material, it is possible to appropriately use well-known light shield paint.

In addition, in steps for forming the fine uneven structure film after the formation of the light shield film, it is possible to consider that disadvantages such as peeling of the light shield film may occur in the previously-formed light shield films during the formation of the fine uneven structure film, and thus it is more desirable to fill concave portions with the flattening member after the formation of the fine uneven structure film. At this time, the flattening member and the light shield film may be provided at the same time using materials capable of serving as the flattening member and the light shield film, and it is also possible to carry out a flattening treatment on fine unevenness using the flattening member and then form the light shield film in light radiation ineffective regions including the surface of the flattening member.

### EXAMPLES

Hereinafter, manufacturing methods and constitutions of lens assemblies of examples and a comparative example of the present invention will be described.

### Example 1

FIG. 4 is a flowchart illustrating a manufacturing step of the lens 1 in a lens assembly of Example 1.

First, a lens material (NPH3) was polished or molded so as to form a single lens (S1), and centering was carried out (S2). An antireflection coating formed of a dielectric multilayer film was formed on a surface 1a opposite to a surface (contact surface) lb facing the other lens 2 (S3). After that, paint (GT1000) manufactured by Canon Chemicals Inc. was applied to the light radiation ineffective portion of the lens in a thickness of 5 μm, thereby forming a light shield film (S4).

After that, a SiON (1) film, a SiON (2) film, and an Al₂O₃ film were continuously formed on the surface (the contact surface) lb facing the other lens 2 using a sputtering method (S5). The refractive index n of SiON (1) at a wavelength of 540 nm was set to 1.845, and the refractive index n of SiON (2) at a wavelength of 540 nm was set to 1.684. The respective thicknesses of the SiON (1) film, the SiON (2) film, and the Al₂O₃ film were set to 63 nm, 110 nm, and 80 nm, respectively. After that, a hot water treatment in which the films were immersed in boiling distilled water for three minutes was carried out, thereby forming a fine uneven structure film (S6). The fine uneven structure film is a film formed of the Al₂O₃ film turned into boehmite by means of the hot water treatment.

After the formation of the fine uneven structure film, a light shield material (paint GT1000 manufactured by Canon Chemicals Inc.) was applied only to the contact portion (edge portion) with the other lens in a thickness of 1 μm, thereby flattening the uneven structure (S7). At this time, the film thickness of the flattening film was set to be thicker than the height of the uneven structure.

A single lens 1 was completed by means of the above-described steps. The edge portion of the lens 1 in Example 1 has a constitution in which, as illustrated in FIG. 3, the light shield film 6 is formed on the lens surface, the fine uneven structure film 4 is formed thereon, and furthermore, the surface is flattened using the flattening member 5. However, in the present example, a flattening layer formed of a SiON layer is further provided between the fine uneven structure film 4 and the lens surface 1b. Meanwhile, the height of the uneven structure formed on the flattening layer was 150 nm.

The other lens 2 was formed by polishing or molding a lens material (LAH55V). After antireflection coatings formed of dielectric multilayer films were formed on both surfaces 2a and 2b, paint (GT7-II) manufactured by Canon Chemicals Inc. was applied to the light radiation ineffective portion in a thickness of 5 μm, thereby completing a single lens 2.

The single lenses 1 and 2 were adjusted and embedded in the lens barrel 3, thereby completing the lens assembly 10. This lens assembly was embedded into an optical system, thereby completing a camera lens. At this time, it was confirmed that there was no dust generated due to the breakage of the uneven structure in optical paths. Specifically, white parallel light was incident on the camera lens in an image surface direction of the lens, scattered light of light penetrating the lens was visually observed, and it was confirmed that scattering did not occur due to foreign substances on the lens surface.

### Example 2

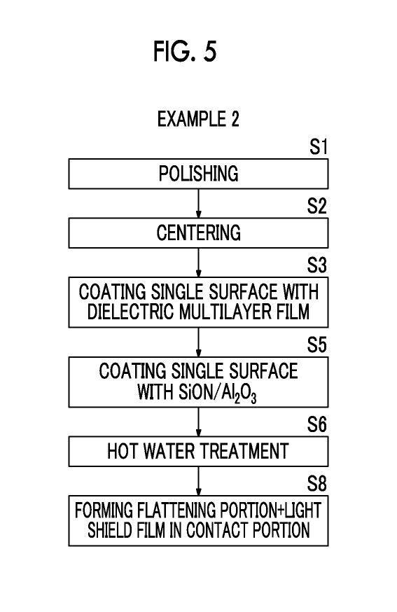

FIG. 5 is a flowchart illustrating a manufacturing step of the lens 1 in a lens assembly of Example 2.

First, a lens material (NPH3) was polished or molded so as to form a single lens (S1), and centering was carried out (S2). An antireflection coating formed of a dielectric multilayer film was formed on a surface 1a opposite to a surface (contact surface) lb facing the other lens 2 (S3).

After that, a SiON (1) film, a SiON (2) film, and an Al₂O₃ film were continuously formed on the surface (contact surface) lb facing the other lens using a sputtering method (S5). The refractive index n of SiON (1) at a wavelength of 540 nm was set to 1.845, and the refractive index n of SiON (2) at a wavelength of 540 nm was set to 1.684. The respective thicknesses of the SiON (1) film, the SiON (2) film, and the Al₂O₃ film were set to 63 nm, 110 nm, and 80 nm, respectively. After that, a hot water treatment in which the films were immersed in boiling distilled water for three minutes was carried out, thereby forming a fine uneven structure film (S6). The fine uneven structure film is a film formed of the Al₂O₃ film turned into boehmite by means of the hot water treatment.

After the formation of the fine uneven structure film, paint (GT1000) manufactured by Canon Chemicals Inc. was applied to the light radiation ineffective portion of the lens in a thickness of 5 μm. At this time, a light shield material was also applied to the contact portion (edge portion) with the other lens, whereby concave portions of the uneven structure were filled with the light shield material, and the uneven structure was flattened (S8).

The lens 1 was completed by means of the above-described steps. The edge portion of the lens 1 in Example 2 has a constitution in which, as illustrated in FIG. 2, concave portions are filled with the light shield film 6 formed on the fine uneven structure film 4 formed on the lens surface and the surface is flattened. In the present example, the light shield film 6 also serves as the flattening member 5. However, in the present example, a flattening layer formed of two kinds of SiON layers is further provided between the fine uneven structure film 4 and the lens surface 1b. Meanwhile, the height of the uneven structure formed on the flattening layer was 150 nm.

The other lens 2 was formed by polishing or molding a lens material (LAH55V). After antireflection coatings formed of dielectric multilayer films were formed on both surfaces 2a and 2b, paint (GT7-II) manufactured by Canon Chemicals Inc. was applied to the light radiation ineffective portion in a thickness of 5 μm, thereby completing a single lens.

The single lenses 1 and 2 were adjusted and embedded in the lens barrel 3, thereby completing the lens assembly 10. This lens assembly was embedded into an optical system, thereby completing a camera lens. At this time, it was confirmed that there was no dust generated due to the breakage of the uneven structure in optical paths.

### Comparative Example

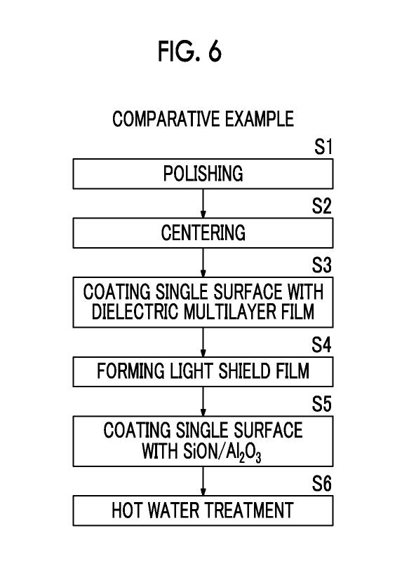

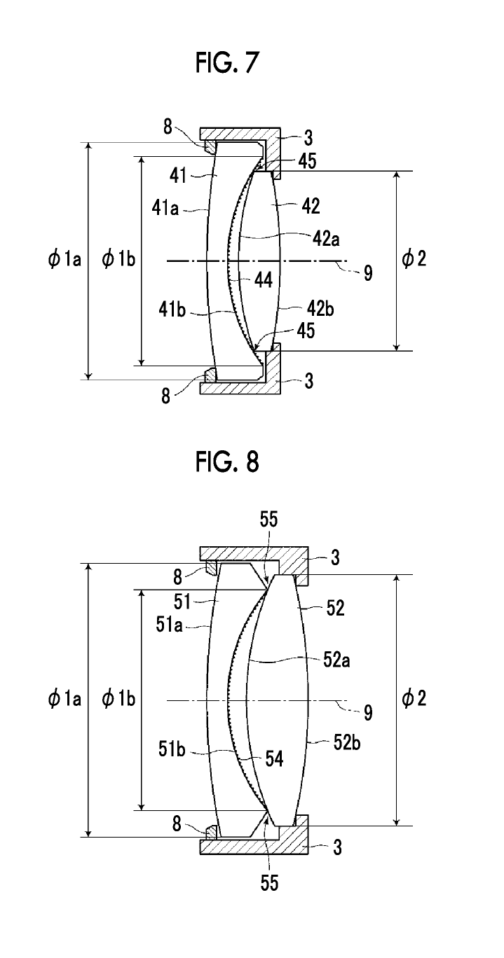

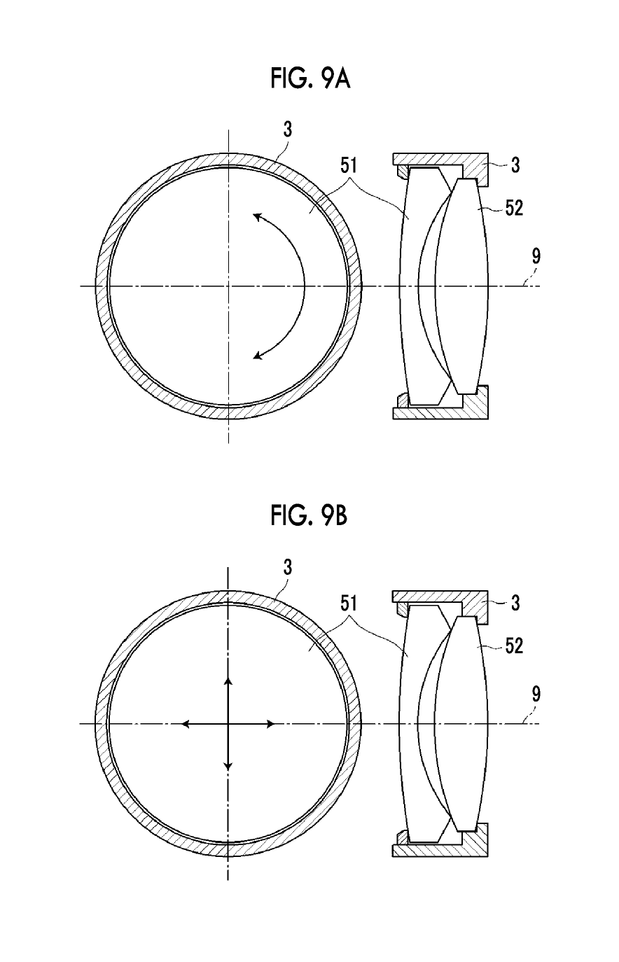

FIG. 6 is a flowchart illustrating a manufacturing step of the lens 1 in a lens assembly of the present comparative example.

First, a lens material (NPH3) was polished or molded so as to form a single lens (S1), and centering was carried out (S2). An antireflection coating formed of a dielectric multilayer film was formed on a surface opposite to a surface (contact surface) facing the other lens 2 (S3). After that, paint (GT1000) manufactured by Canon Chemicals Inc. was applied to the light radiation ineffective portion of the lens in a thickness of 5 μm, thereby forming a light shield film (S4).

After that, a SiON (1) film, a SiON (2) film, and an Al₂O₃ film were continuously formed on the surface (the contact surface) facing the other lens using a sputtering method (S5). The refractive index n of SiON (1) at a wavelength of 540 nm was set to 1.845, and the refractive index n of SiON (2) at a wavelength of 540 nm was set to 1.684. The respective thicknesses of the SiON (1) film, the SiON (2) film, and the Al₂O₃ film were set to 63 nm, 110 nm, and 80 nm, respectively. After that, a hot water treatment in which the films were immersed in boiling distilled water for three minutes was carried out, thereby forming a fine uneven structure film (S6). The fine uneven structure film is a film formed of the Al₂O₃ film turned into boehmite by means of the hot water treatment. The height of the formed uneven structure was 150 nm.

A single lens was completed by means of the above-described steps. In the comparative example, the lens has a constitution in which the flattening member 5 is not provided to the lens 1 of Example 1. Therefore, even in the edge portion, the fine uneven structure film is exposed.

The other lens was formed by polishing or molding a lens material (LAH55V). After antireflection coatings formed of dielectric multilayer films were formed on both surfaces, paint (GT7-II) manufactured by Canon Chemicals Inc. was applied to the light radiation ineffective portion in a thickness of 5 μm, thereby completing another single lens.

The two lenses formed as described above were adjusted and embedded in the lens barrel 3, thereby completing the lens assembly. This lens assembly was embedded into an optical system, thereby completing a camera lens. At this time, it was confirmed that there was dust generated due to the breakage of the uneven structure in optical paths.

What is claimed is:

1. A lens assembly constituted of two lenses which have light radiation effective portions facing each other and are disposed such that one of the lenses comes into contact with the other lens at an edge portion that is a boundary between a curved surface and an outer peripheral portion of the one lens,
wherein the one lens has a functional film formed of a fine uneven structure film throughout an entire region including an edge portion of a lens surface facing the other lens, and a portion of the fine uneven structure film within a light radiation ineffective portion of the one lens extending over the curved surface and the outer peripheral portion forming the edge portion and including the edge portion is filled with a flattening member and is thus flattened.

2. The lens assembly according to claim 1,
wherein a light shield film is provided in at least the light radiation ineffective portion in the one lens.

3. The lens assembly according to claim 2,
wherein the flattening member is made of the same material as that of the light shield film.

4. The lens assembly according to claim 2,
wherein, in the edge portion, the light shield film is provided between the fine uneven structure film and the lens surface.

5. The lens assembly according to claim 3, wherein, in the edge portion, the light shield film is provided between the fine uneven structure film and the lens surface.

6. The lens assembly according to claim 1,
wherein the fine uneven structure film is made of a composition including a hydrate of aluminum or alumina as a main component.

7. The lens assembly according to claim 2,
wherein the fine uneven structure film is made of a composition including a hydrate of aluminum or alumina as a main component.

8. The lens assembly according to claim 3,
wherein the fine uneven structure film is made of a composition including a hydrate of aluminum or alumina as a main component.

9. The lens assembly according to claim 4,
wherein the fine uneven structure film is made of a composition including a hydrate of aluminum or alumina as a main component.

10. The lens assembly according to claim 5,
wherein the fine uneven structure film is made of a composition including a hydrate of aluminum or alumina as a main component.
